(19) United States
(12) Patent Application Publication
(10) Pub. No.: US 2001/0027409 A1
(43) Pub. Date: Oct. 4, 2001

(54) Marketing research method, printed matter to be used for such a marketing research and information resource to be utilized for such a marketing research

(75) Inventors: Hiroshi Sasaki, Hachioji-shi (JP); Mutsumi Kikuchi, Akishima-shi (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Olympus Optical Co., Ltd, Tokyo (JP)

(21) Appl. No.: 09/813,033

(22) Filed: Mar. 20, 2001

(30) Foreign Application Priority Data
Mar. 23, 2000 (JP) 2000-082789
Nov. 24, 2000 (JP) 2000-358152

(51) Int. Cl. G06F 17/60

(52) U.S. Cl. 705/10

(57) ABSTRACT

A printed matter having copies to be distributed to specified or unspecified persons comprises a part carrying visually readable printed image including characters and/or photographic image, and a part carrying an optically readable dot code as obtained by encoding the URL to be used for specifying an information resource for the printed matter on WWW connected to Internet by an access device. As the dot code is scanned by a reading device, the URL is restored and the information resource that corresponds to the URL is accessed by the access device. With this arrangement, access information on the accesses to the information resource is accumulated in the data base server of the issuer of the printed matter. Then, the issuer of the printed matter can study and/or analyze the information on the printed matter by utilizing the access information accumulated in the data base server.

### CROSS-REFERENCE TO RELATED APPLICATIONS

This application is based upon and claims the benefit of priority from the prior Japanese Patent Applications No. 2000-082789, filed Mar. 23, 2000; and No. 2000-358152, filed Nov. 24, 2000, the entire contents of both of which are incorporated herein by reference.

### BACKGROUND OF THE INVENTION

This invention relates to a marketing research method that can be used for a marketing research on copies of a printed matter containing visually readable printed images including characters and photographic images that are distributed to specified or unspecified readers as well as to a printed matter that can be used for such a marketing research and to an information resource that can be utilized for such a marketing research.

There are a large number of printed matters containing visually readable printed images whose copies are to be distributed to specified or unspecified readers. Such printed matters include newspapers, magazines, books, journals, pamphlets, catalogs, leaflets and tickets. Conventionally, the simple method of looking into the number of sold or distributed copies of a particular printed matter is used to see the extent to which the printed matter attracts attention of or is responded by the readers. In other words, the number of sold or distributed copies is utilized in a marketing research as data indicating the extent to which the printed matter attracts attention of or is responded by the readers.

However, with such a marketing research technique, it is highly difficult for the issuer of the copies to accurately know if some of the readers simply paid attention to the printed matter or were interested in an article or an advertisement contained therein. Therefore, such a marketing research technique for printed matters is confronted by certain limitations in terms of accuracy and reliability.

Particularly, if it is necessary to know the attention or the responses of the readers to a particular article or advertisement contained in a newspaper or a magazine, it is practically impossible and risky to judge the attention or the responses simply on the basis of the number of the sold copies of the newspaper or the magazine. Furthermore, in the case of a pamphlet, a catalogue or a leaflet whose copies are distributed free to unspecified people, it is extremely difficult to know the attention or the responses of the readers because no data is available on the number of copies that are actually read by the people who received them.

Therefore, there is a demand for a novel marketing research technique that can be used directly to know more accurately the extent of attention or responses of the readers not only to a printed matter as a whole but also to each of the articles and the advertisements contained in it.

Meanwhile, almost anyone who wants to acquire the information he or she wants can do so by accessing one or more than one information resources on the Word Wide Web (to be referred to as WWW hereinafter) connected to Internet that is a worldwide computer network by an access device such as personal computer that is rapidly becoming popular in ordinary households.

The person who accesses an information resource specifies it by a URL (uniform resource locator). A URL is typically expressed by a string of characters such as http://www.abcdef.co.jp., of which www.abcded.co.jp. denotes the server of an information provider on the WWW and is followed by a folder name or a file name.

Thus, as described in Jpn. Pat. Appln. KOKAI Publication No. 10-078928, if a URL is assigned to a number comprising a relatively small number of digits and expressed in the form of a bar code and the bar coded is carried by a printed matter, the person who wants to access the information resource with the URL can do so by optically reading the bar code by a dedicated reading device connected to the access device. Then, the access device is linked to the printed matter.

However, while the method described in the above identified patent document is adapted to look into and analyze the number of accesses to the information resource, it is not designed to look into the extent of attention or responses to the information resource, which may be a printed matter such as a newspaper or a magazine, nor to any of the articles or the advertisements contained in the printed matter.

Jpn. Pat. Applns. KOKAI Publication Nos. 10-171758, 10-177613 and 9-152924 and U.S. Pat. No. 5,640,193 also described a technique for easily accessing information resources by using bar codes for URLs. However, none of the above patent documents disclose nor suggest a marketing research technique for printed matters.

The inventors of the present invention achieved this invention by paying attention to that a technique of linking electronic information and printed matters by utilizing Internet can advantageously be used as marketing research technique for printed matters and that an action of reading a one-dimensional or two-dimensional bar code or an optically readable coded image in a form or another that is printed on a printed matter should indicate that the person who performed that action is interested in the printed matter.

### BRIEF SUMMARY OF THE INVENTION

In view of the above identified circumstances, it is therefore the object of the present invention to provide a marketing research method that can be used to easily and accurately look into and analyze the extent of attention and responses to copies of a printed matter containing visually readable printed images including characters and photographic images that are distributed to specified or unspecified readers as well as a printed matter that can be used for such a marketing research and an information resource that can be utilized for such a marketing research.

According to a first aspect of the present invention, there is provided a marketing research method for at least one of studying and analyzing a printed matter containing visually readable printed image including at least one of characters and photographic image and an optically readable coded image as obtained by encoding the URL to be used for specifying an information resource for the printed matter on World Wide Web connected to Internet by an access device, copies of the printed matter being distributed to one of specified and unspecified persons, the method comprising the steps of:

storing access information obtained for each access to the information resource as a result of an operation of optically reading the coded image of a reading device, restoring the URL from the read coded image and accessing the information resource corresponding to the restored URL by the access device connected to the reading device; and

at least one of studying and analyzing the printed matter by utilizing the access information on the accesses as stored in the information resource.

According to a second aspect of the present invention, there is provided a printed matter having copies to be distributed to at least one of specified and unspecified persons and to be used for a marketing research, the printed matter comprising:

a part carrying visually readable printed image including at least one of characters and photographic image; and

a part carrying an optically readable coded image as obtained by encoding the URL to be used for specifying an information resource for the printed matter on World Wide Web connected to Internet by an access device, wherein

when the coded image is optically read by a reading device, the URL is restored from the read coded image and the information resource corresponding to the restored URL is accesses by the access device connected to the reading device, access information on the accesses in the information resource is utilized for a marketing research for at least one of studying and analyzing the printed matter.

According to a third aspect of the present invention, there is provided an information resource to be used in a marketing research for at least one of studying and analyzing a printed matter containing visually readable printed image including at least one of characters and photographic image and an optically readable coded image as obtained by encoding the URL to be used for specifying an information resource for the printed matter on World Wide Web connected to Internet by an access device, copies of the printed matter being distributed to one of specified and unspecified persons, the marketing research utilizing access information obtained for each access to the information resource as a result of an operation of optically reading a coded image of a reading device, restoring the URL from the read coded image and accessing the information resource corresponding to the restored URL by the access device connected to the reading device; the information resource comprising:

information transmission means for transmitting the information to be displayed on the access device in response to an access by the access device; and

storage means for storing the access information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic illustration of the physical format of a dot code shown as a typical example of optically readable coded image to which the present invention is applicable;

FIG. 2 is a schematic block diagram of a system to which the first embodiment of marketing research method according to the invention is applied;

FIG. 3 is a schematic illustration of a dot code that can be used for the first embodiment of marketing research method according to the invention;

FIG. 4 is a schematic illustration of a result that can be obtained by the first embodiment of marketing research method according to the invention;

FIG. 5 is a schematic illustration of another result that can be obtained by the first embodiment of marketing research method according to the invention;

FIG. 6 is a schematic illustration of a dot code that can be used for the second embodiment of marketing research method according to the invention;

FIG. 7 is a schematic illustration of a printed matter that can be used for the second embodiment of marketing research method according to the invention;

FIG. 8 is a schematic illustration of a dot code that can be used for the modified second embodiment of marketing research method according to the invention;

FIG. 9 is a schematic illustration of a result that can be obtained by the modified second embodiment of marketing research method according to the invention;

FIG. 10 is a schematic illustration of a dot code that can be used for the third embodiment of marketing research method according to the invention;

FIG. 11 is a schematic illustration of the operation of an access device when a dot code is scanned in the third embodiment of marketing research method according to the invention; and

FIG. 12 is a flow chart of a scanning operation of the third embodiment of marketing research method according to the invention.

### DETAILED DESCRIPTION OF THE INVENTION

Now, the present invention will be described by referring to the accompanying drawing that illustrates preferred embodiments of the invention. But, firstly, a dot code will be described as an example of optically readable coded image that can suitably be used for the purpose of the present invention.

It may be appreciated, however, that the present invention is applicable to various one-dimensional or two-dimensional coded images other than dot codes.

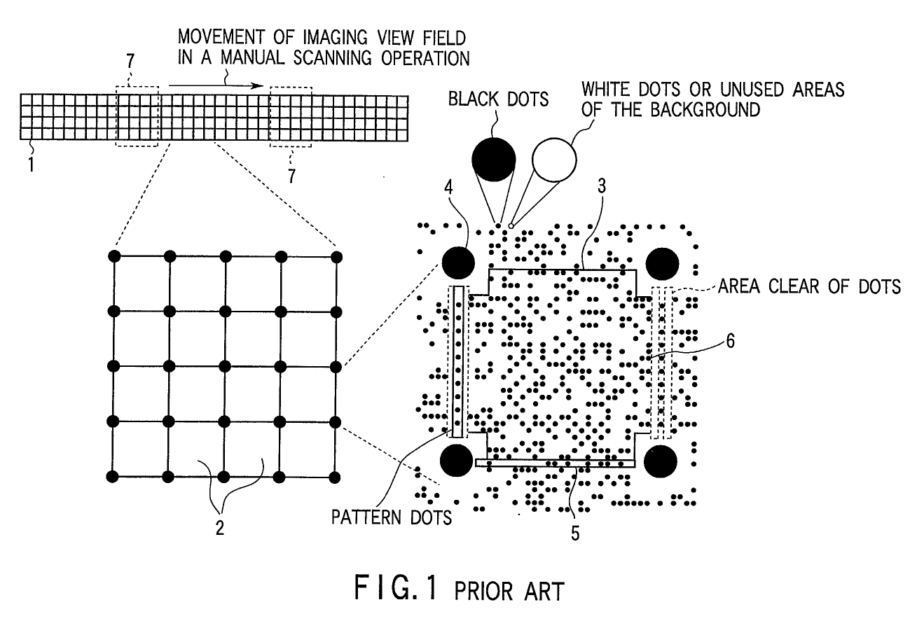

FIG. 1 is a schematic illustration of the physical format of a dot code. A dot code having such a physical format is already proposed in U.S. Pat. No. 5,896,403 and U.S. Pat. No. 5,866,895.

Referring to FIG. 1, the dot code 1 is printed on a page of a printed matter in such a way that it can be optically read by a manual scanning operation using a dedicated reading device.

More specifically, the dot code 1 comprises a plurality of blocks 2 that are arranged two dimensionally side by side. Each of the blocks 2 contains a data dot pattern section 3, markers 4 and a block address pattern 5. The data dot pattern section 3 represents a part of the character data of a URL or a sound data to be recorded as dot code there that is obtained by dividing the data and assigned to the block. The data dot pattern section 3 is an area containing black dots and white dots (which are not discernible on the white background but still can be read as white dots) that represent so many “1s” and so many “0s” respectively. The markers 4 are used to detect so many reference points for reading the dots (the data dots 6) in the data dot pattern section 3 and arranged at the four corners of the block 2. Each marker is formed by continuously arranging a predetermined number of black dots. The block address pattern 5 is arranged between a pair of markers 4 and contains the address of the block so that the block may be identified when a plurality of different blocks are read by a reading device. Note that the block address pattern 5 contains an error detection code or an error correction code.

With the above arrangement, if the overall size of the dot code 1 is larger than the visual field of the reading device and hence cannot be picked up by a single shot of the reading device, the entire data of the dot code 1 can be rearranged and retrieved on the basis of the data of each of the blocks read by the reading device only if the address of each of the blocks 2 is detected with the data dot 6 of the block 2.

Thus, with the above described technique, it is possible to record a large volume of data on a sheet of paper and can be read by a manual scanning operation.

Now, the present invention will be described by referring to the accompanying drawing that illustrates preferred embodiments of the invention.

1st Embodiment

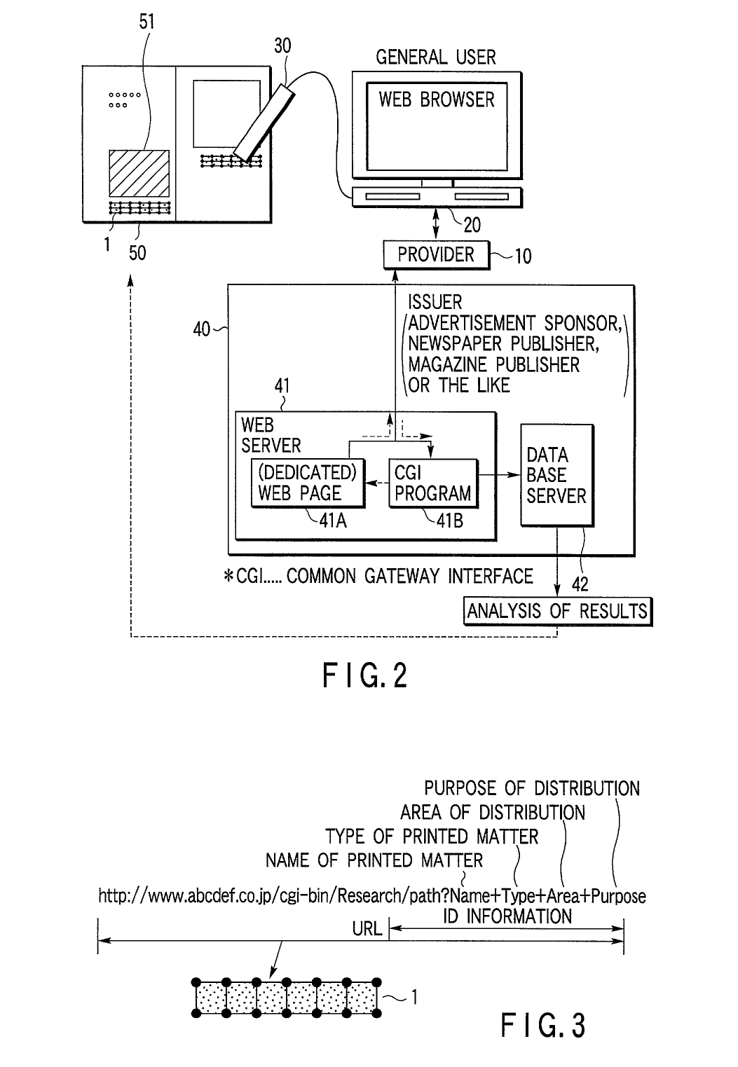

FIG. 2 is a schematic block diagram of a system to which the first embodiment of marketing research method according to the invention is applied.

The user who may be a specified person or an unspecified person possesses a personal computer (PC) that operates as an access device 20 and can be connected to Internet by way of an Internet service provider 10 and a reading device 30 that can be connected to the access device 20 by way of a cable or a wireless transmission path to read a dot code 1.

Copies of printed matters 50 such as pamphlets, newspapers, magazines, books, journals, catalogs, leaflets, name cards, various tickets and even blocks containing commodities have been issued by advertisement sponsors, newspaper publishers, magazine publishers and other issuers and the user has bought one of them and keeps it at hand. The printed matter 50 carriers thereon a visually readable printed image 51 that the user can visually read and a dot code 1, or an optically readable coded image arranged at a position corresponding to the visually readable printed image 51, which may be an advertisement or a news article.

The issuer 40 is equipped with a web server 41 having the information resource of the printed matter 50 and arranged on the World wise Web (WWW) and a data base server 42 that stores various data and is controlled in such a way that any of the data stored there may be retrieved at any time. The web server 41 is provided with a CGI (Common Gateway Interface) program 41B to be used to produce the information resource of the visually readable printed image 51 on the printed matter 50, for example, a web page 41A that may be an ordinary web page or a dedicated web page and adapted to produce very detailed data for the advertisement or the news article.

The CGI program is started by appropriate information transmitted from the user's access device 20 by way of the Internet service provider 10.

More specifically, referring to FIG. 3, the dot code 1 printed on the printed matter 50 contains the URL (Uniform Resource Locator) that is coded and to be used by the access device 20 to specify and access the information resource of the printed matter 50 on the WWW connected to Internet. In FIG. 3, the former half (http://www.abcdef.co.jp/cgi-bin/Research/) of the URL corresponds to the name of the executed CGI program 41B. The latter half of the URL represents the ID (identification) information to be delivered to the CGI program 41B as parameter data. As shown in FIG. 3, the ID information may include the name (Name) of the printed matter 50, the type (Type) of the printed matter 50, the distribution area (Area) of copies of the printed matter 50, the purpose of distribution (Purpose) of copies of the printed matter 50, showing the advertisements and/or the articles contained in the printed matter 50, and the day of distribution.

After reading the printed matter 50, if the user is interested in a particular readable image 51, which may be an advertisement or an article, he or she may try to obtain more detailed information on the readable image 51. Then, the user will manually scan the dot code 1 printed on the printed matter 50 as coded image by the reading device 30. As a result, the reading device 30 reads and restores the coded URL contained in the dot code 1. The restored URL is then input to the access device 20 connected to the reading device 30, which access device 20 by turn accesses the web server 41 corresponding to the URL by way of the service provider 10.

Then, the CGI program 41B is started in the web server 41 by the information transmitted from the provider 10 and takes in the ID information contained in the dot code 1. Additionally, the CGI program 41B obtains the reading of the access counter, the date and time of the access, information on the access person which is specific to the person who accesses it and includes the geographical information of the access device 20 that accesses it, and so on. Then, the CGI program 41B stores the obtained information in the data base server 42.

Furthermore, the CGI program 41B sends a dedicated or general purpose web page back to the user who scanned the dot code 1 on the printed matter 50.

The issuer 40 looks into and analyzes the access information (including the number of accesses and the date and time of the information resource and the information on each of the access persons) for the printed matter 50 collected and stored in the data base server 42 so that the obtained results of the analysis may be effectively reflected on the next issue of the printed matter 50. In other words, the issuer 40 can compile the next issue of the printed matter 50 on the basis of the information indicating the types of articles and those of advertisements as well as the locations of advertisements in the printed matter 50 where the user will take interest, regardless if the printed matter 50 is a newspaper or a pamphlet.

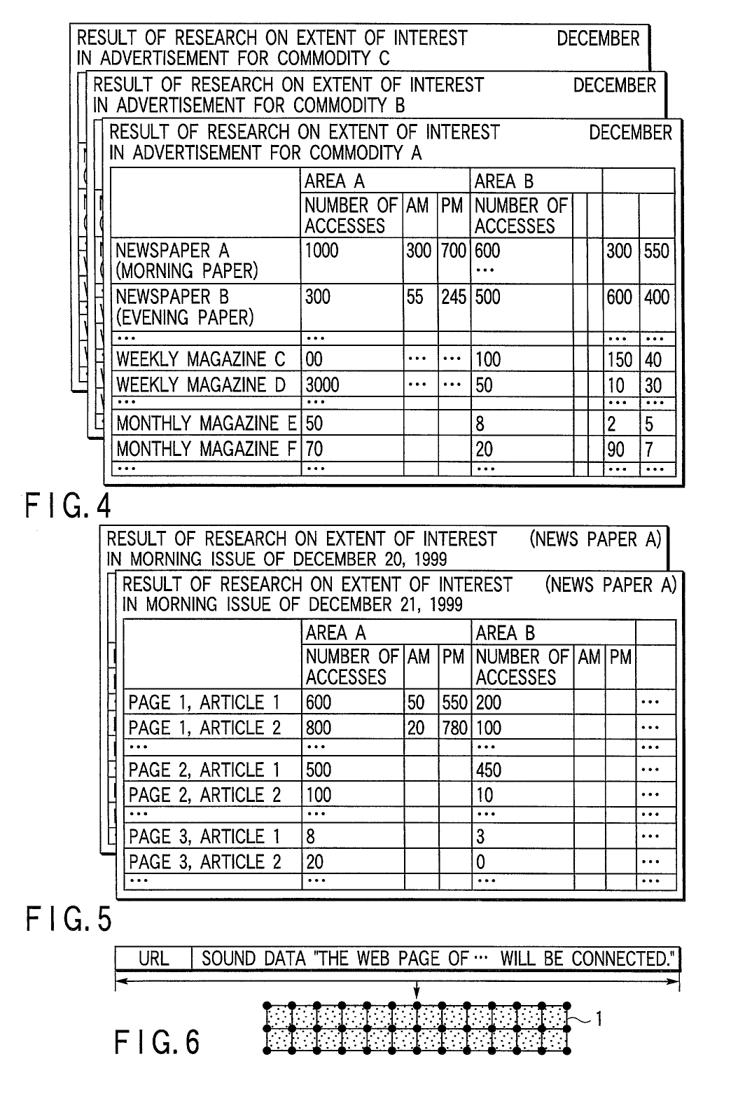

FIG. 4 is a schematic illustration of a result that can be obtained by the first embodiment of marketing research method according to the invention and used by an issuer 40, who may be an advertisement sponsor, a newspaper publisher or a magazine publisher, on the basis of the data stored in the data base server 42. Note that it shows a summary of a research operation conducted to see the interest taken by the users in an advertisement of each commodity. In FIG. 4, the types of printed matters used for the advertisement are listed in the first column and the number of accesses in specific areas (e.g., states, cities and so on) and the time zones of accesses are shown for each of the printed matters 50. Such a summary of a research operation can be retrieved from the data base server 42 for any commodity for which such a research operation is conducted.

Thus, a new business model for the issuer of a newspaper or a magazine may be devised, in which the issuer first distributes a free advertisement in a newspaper or a magazine, then counts the accesses made to the advertisement, and finally charges the advertisement sponsor the price for the advertisement if the number of accesses exceeds a predetermined value.

In other words, the price that the issuer of the newspaper or the magazine charges the advertisement sponsor most accurately reflects the extent of attention and responses to the advertisement sponsored by the advertisement sponsor.

FIG. 5 is a schematic illustration of another result that can be obtained by the first embodiment of marketing research method according to the invention, where the issuer 40 is a newspaper publisher and the printed matter 50 is a specific issue of a newspaper, while the readable image 51 is a news article. In FIG. 5, the articles of a specific issue of the newspaper are listed in the first column and the number of accesses to each of the articles in each of the selected specific areas is shown in the corresponding column.

2nd Embodiment

Now, the second embodiment of the invention will be described.

In the second embodiment, as is shown in FIG. 6, the dot code 1 that is an optically readable coded image printed on a printed matter 50 contains coded sound data in addition to a coded URL as described above by referring to the first embodiment.

When such a dot code 1 is used, the information resource (web page) can be accessed by scanning the dot code 1 by a reading device 30 as in the case of the first embodiment and, at the same time, a voice reading the URL and saying “The web page of . . . will be connected.” can be produced from the reading device 30.

If the printed matter 50 is a pamphlet, the information resource (web page) is provided by the pamphlet issuer and the access information will include the number of accesses to the information resource, the date and time of each access, or the information on each access person. While the URL shown in the dot code 1 preferably includes ID information, although it may not necessarily include ID information. If it includes ID information, the ID information may by turn include the name, the type, the date of distribution and the distribution area of the pamphlet, the purpose of distribution of copies of the pamphlet, and so on.

If, on the other hand, the printed matter 50 is a newspaper, the information resource (web page) is provided by the newspaper publisher. The access information will include the number of accesses to the information resource about each of the articles of the newspaper, the date and time of each access or the information on each access person so that the newspaper publisher can sum up the data on each article to see and analyze them. The ID information contained in the URL shown in the dot code 1 includes the name of the newspaper, the date of issue of the newspaper (the identifier for morning newspaper or evening newspaper), the distribution area of copies of the newspaper, information for identifying the article, and so on.

If the printed matter 50 is a newspaper or a magazine, the information resource (web page) may be provided by the sponsor of a specific advertisement in the newspaper or the magazine. If such is the case, the access information will include the number of accesses to the information resource of the advertisement, the date and time of each access and the information on each access person about each of the advertisements. Furthermore, the access information will include the number of accesses to the information resource of the advertisement, the date and time of each access and the information on each access person about each of the newspapers or the magazines. Then, if the advertisement is shown in a number of newspapers and/or magazines, the advertisement sponsor can sum up the data on each of the advertisements or on each of the newspapers and/or the magazines showing the advertisement to see and analyze them. The ID information contained in the URL shown in the dot code 1 includes the name of the newspaper or the magazine, the date of issue of the newspaper or the magazine (the identifier for morning newspaper or evening newspaper if the printed matter is a newspaper), the distribution area of copies of the newspaper or the magazine, information for identifying the advertisement and so on.

When an advertisement on a commodity is shown in a newspaper or a magazine with a coded image containing the name of the URL to be accessed, the information resource corresponding to the URL may be that of the advertising agent responsible for the advertisement instead of the information resource of the newspaper publisher or the magazine publisher or that of the vendor of the commodity (advertisement sponsor). Then, the advertising agent can directly analyze the information on the readers of the advertisement and make the outcome of the analysis to be reflected on the next advertisement that is to be shown in the newspaper or the magazine to increase the value of the analysis.

The information resource of the advertising agent may be arranged between the access device of each user (reader) and the information resource of the newspaper publisher or the magazine publisher or that of the advertisement sponsor so that the user accesses the information resource of the publisher or that of the advertisement sponsor by way of the information resource of the advertising agent. With such an arrangement, information on accesses may be stored only in the information resource of the advertising agent and web page information on the commodity may be provided only from the information resource of the publisher or that of the advertisement sponsor. Then, the publisher or the advertisement sponsor can rely on the advertising agent for marketing researches on the commodity while the advertising agent can sort and analyze the access information stored in the own information resource and provide the advertisement sponsor with the outcome of the analysis so that the advertising agent may be able to obtain new service opportunities.

The access information of each access device (user) may be made to contain personal information specific to the user including the age, the sex and the occupation of the user that is originally contained in the dot code reading device of the user or the decoding software of the dot code reading device. Then, each time the user reads a dot code by his or her dot code reading device and accesses the information resource of the advertising agent shown in the dot code, the access information specific to the user that is originally contained in the reading device of the user or the decoding software of the reading device may also be transmitted to the information resource so that the advertising agent can easily obtain the access information.

It may be needless to say that the dot code 1 may contain coded image data or text data indicating the URL in stead of sound data. Then, the image or text reproduced from the coded image data will be displayed on the display screen of the PC that is operating as access device 20.

The recorded data that are obtained by coding the dot code 1 are not limited to sound data that may be a voice reading the URL or image or text data indicating the URL.

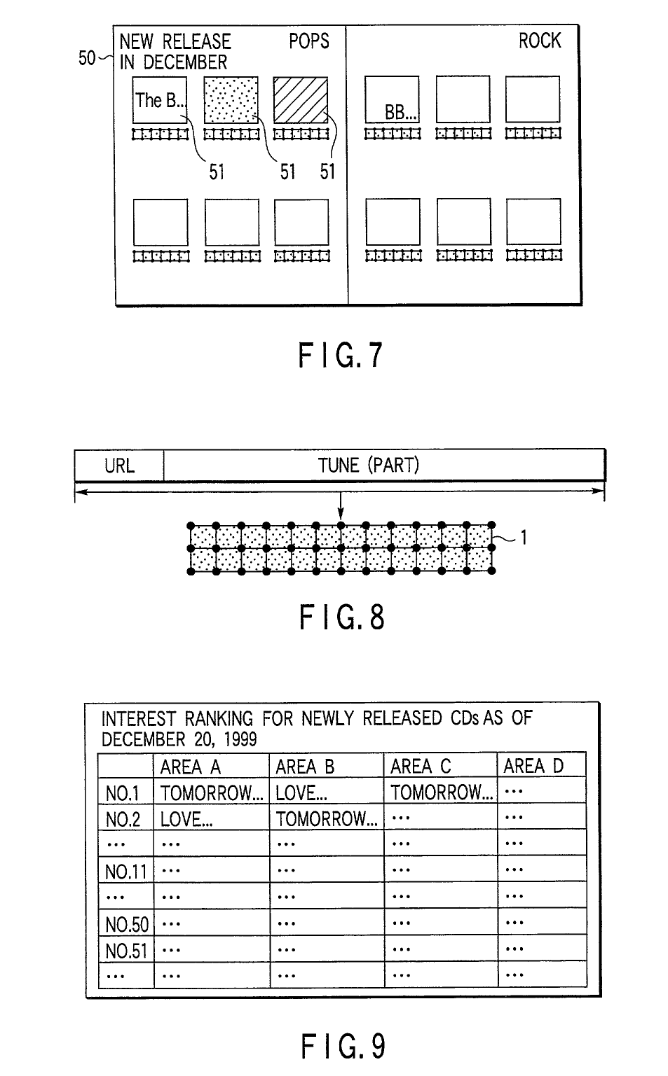

For instance, if the printed matter 50 is a music magazine as shown in FIG. 7, a dot code 1 corresponding to a visually readable printed image 51 such as the photograph on the jacket of a CD may be recorded under the photograph so as to contain part of one of the pieces of music recorded on the CD as part of the dot code 1 as shown in FIG. 8.

With such an arrangement, the user can listen to a leading part or a climax part of the piece contained in the CD by the reading device 30 as he or she scans the dot code 1 with the device 30.

Then, as in the case of the first embodiment, the user can access the information resource (web page 41A) of the music magazine publisher 40 by the access device 20 to retrieve detailed or in-depth information on the CD and/or the publisher.

On the other hand, since the CGI program 41B is started each time the information resource is accessed to store access information in the data base server 42 as in the case of the first embodiment, the publisher 40 can see information on CDs that are currently popular. In other words, the publisher 40 can retrieve the outcome of CD popularity ranking researches as shown in FIG. 9. Additionally, the outcome of CD popularity ranking researches can be made available to the users of access devices if the CGI program 41B is so designed as to show it on the web page 41A by the data base server 42.

Currently, CD retail shops are provided with headphones so as to allow expected buyers to tentatively listen to a CD. With this embodiment, it may be so arranged that a CD and a corresponding dot code 1 are placed side by side in the CD retail shop and any expected buyer visiting the shop can listen any of the pieces of music recorded in the CD by scanning the dot code 1 by a reading device 30. If the ID information of the URL contained in the dot code 1 includes data for identifying the CD retail shop as regional information, CD popularity ranking researches can be conducted for the CD retail shop.

3rd Embodiment

Now, the third embodiment of the invention will be described.

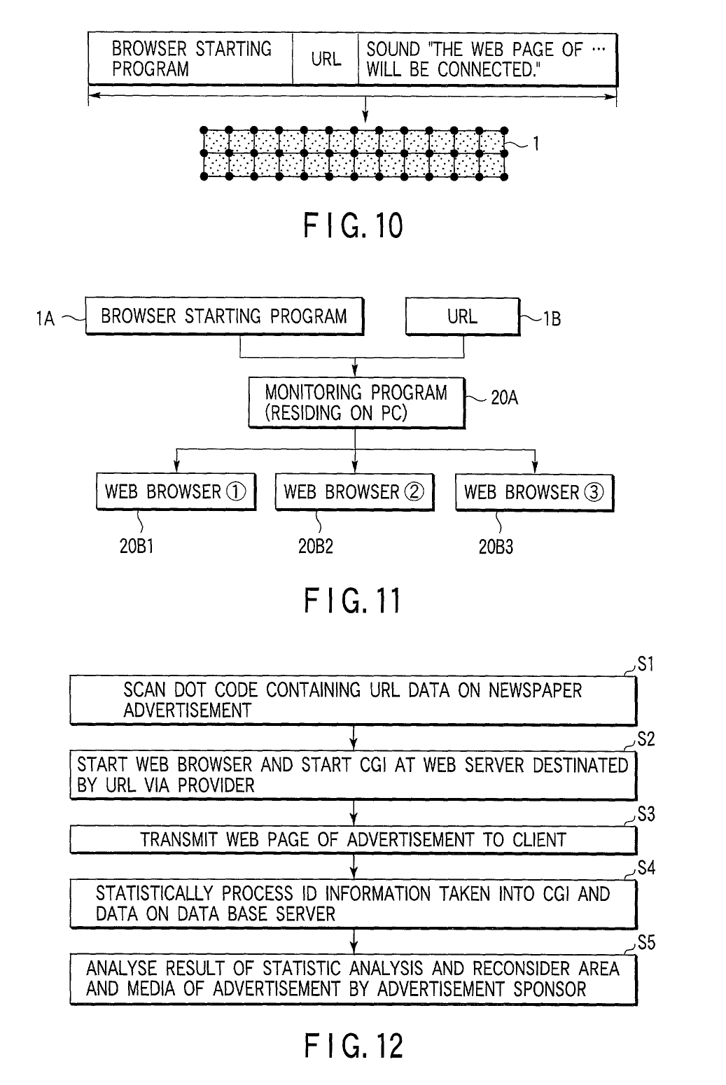

As shown in FIG. 10, the third embodiment of the invention is adapted to make the dot code 1 shown on a printed matter 50 as optically readable coded image contain information on the program for starting a browser in addition to the related URL and sound data as described above by referring to the second embodiment.

As such a dot code 1 is scanned by a reading device 30, monitor program 20A that resides in the PC operating as access device 20 and operating in the background as shown in FIG. 11 takes in the browser starting program 1A and the URL 1B obtained by the reading device 30. Then, the monitor program 20A selects the web browser to be started out of the plurality of web browser installed in the PC (web browsers 20B1, 20B2 and 20B3 in the case of FIG. 11) based on the browser starting program 1A and starts the selected web browser. This is because, if the web page shown in the URL 1B contains Java Applet for instance, a browser for reproducing it is required. With the arrangement of the third embodiment, the issuer 40 of the printed matter 50 whose may be a publisher or an advertisement sponsor can control the web browser to be started.

FIG. 12 is a flow chart of a scanning operation of the third embodiment of marketing research method according to the invention.

Referring to FIG. 12, as the user scans a dot code 1 containing URL data and typically shown on a newspaper advertisement by the reading device 30 (Step S1), the user's access device 20 starts the right web browser as indicated by the browser starting program 1A contained in the dot code 1 and the URL restored from the dot code 1 is transmitted to the target web server 41 by way of the service provider 10 to start the CGI program 41B (Step S2). The started CGI program 41B then transmits the (dedicated or general purpose) web page of the advertisement to the client, or the user who scanned the dot code 1 by his or her reading device 30 (Step S3). At the same time, the web server 41 performs a statistic processing operation on the ID information taken into the CGI program 41B and the data stored in the data base server 42 (Step S4) and the advertisement sponsor analyzes the report on the statistic and may discuss the regions and media of advertisement and/or the design of the advertisement (Step S5).

If the printed matter 50 is a pamphlet, the information resource (web page) is that of the issuer of the pamphlet. Then, the access information may include the number of accesses and the date and time of each of the accesses or the information on each of the access persons. While the dot code 1 may or may not contain ID information in the URL, it preferably contains such ID information. Then, the ID information may include the name (the type) of the pamphlet, the date of distribution of copies of the pamphlet the distribution area of copies of the pamphlet, the purpose of distribution of copies of the pamphlet, and so on.

The dot code 1 may contains a starting program of a document preparation program, that of a spreadsheet program and/or that of some other application program in addition to the browser starting program.

In place of such starting programs, the dot code may contain file names including extenders as information on the starting programs for starting application programs.

While the present invention is described in terms of preferred embodiments, the present invention is by no means limited to the above described embodiments, which may be modified or altered in various different ways without departing from the scope of the present invention.

For instance, while a PC is used as access device in each of the above described embodiments, it may be replaced by some other access device such as a mobile telephone set or PDA (Personal Data Assistants). Then, the mobile telephone or PDA may comprise a reading device as integral part thereof.

The present invention will be summarily described below.

(1) A marketing research method for at least one of studying and analyzing a printed matter containing visually readable printed image including at least one of characters and photographic image and an optically readable coded image as obtained by encoding the URL to be used for specifying an information resource for the printed matter on World Wide Web connected to Internet by an access device, copies of the printed matter being distributed to one of specified and unspecified persons, the method comprising the steps of:

storing access information obtained for each access to the information resource as a result of an operation of optically reading the coded image of a reading device, restoring the URL from the read coded image and accessing the information resource corresponding to the restored URL by the access device connected to the reading device; and

at least one of studying and analyzing the printed matter by utilizing the access information on the accesses as stored in the information resource.

The printed matter contains visually readable printed image such as characters or photographic image and a coded image optically readable to an access device as obtained by encoding the URL. Therefore, if a reader is interested in the printed matter after reading or seeing it and wants to obtain more detailed information on it, he or she will reads the coded image printed on the printed matter by a reading device to restore the URL and then access the information resource on the WWW as specified by the URL.

Thus, it is possible to accurately and easily study and/or analyze the information accumulated for the printed matter by utilizing the information on the accesses to the information resource.

Additionally, when a printed matter is made to carry a coded image of an URL by printing, the reliability of the character data of the URL can be improved in a simple way by using an error correction technique so that the URL can be read more accurately and reliably if compared with a case where the character string of the URL is simply optically read by an OCR (optical character reader) and the information resource on the WWW is accessed by using the restored URL. As a result, for example, it will become possible to select the paper as deemed optimal for the copies of the printed matter to be distributed from a wide variety of different types of paper.

(2) The marketing research method according to (1) above, wherein the information resource corresponding to the URL as restored from the coded image is an information resource adapted to at least on of studying and analyzing the printed matter.

With this arrangement, an information resource is provided for marketing researches apart from the ordinary information resource of the printed matter so that subsequent statistic operations for the study and/or the analysis on the printed matter can be conducted easily and efficiently.

(3) The marketing research method according to (1) or (2) above, wherein the URL includes ID information for identifying the printed matter.

With this arrangement, since the URL includes ID information for identifying the printed matter, the information on the printed matter can be automatically sorted out for the study and/or the analysis on the printed matter so that the subsequent statistic operations for the study and/or the analysis on the printed matter can be conducted easily and efficiently.

(4) The marketing research method according to (3) above, wherein the ID information includes at least one of a name of the printed matter, a type of the printed matter, a date of distribution of copies of the printed matter, a distribution area of copies of the printed matter and a purpose of distribution of copies of the printed matter as identifiable information.

With this arrangement, since the ID information includes at least one of the name of the printed matter, the type of the printed matter, the date of distribution of copies of the printed matter, the distribution area of copies of the printed matter and the purpose of distribution of copies of the printed matter as identifiable information, the subsequent statistic operations for the study and/or the analysis on the printed matter can be conducted easily and efficiently.

(5) The marketing research method according to (1) above, wherein the coded image further contains a browser starting program for starting a browser for the access device.

With this arrangement, since the coded image further contains a browser starting program for starting a browser for the access device, the person who accesses the information resource can immediately access it simply by reading the coded image without starting the browser.

(6) The marketing research method according to (1) above, wherein the printed matter is one of a newspaper, a magazine, a book, a journal, a pamphlet, a catalog, a leaflet and a ticket.

With this arrangement, it is possible to study and/or analyze the extent of attention and/or responses to the printed matter that may be a newspaper, a magazine, a book, a journal, a pamphlet, a catalog, a leaflet or a ticket.

(7) The marketing research method according to (1) above, wherein

if the printed matter carries at least one of a plurality of articles and advertisements and the at least one of each article and each advertisement shown on the printed matter is provided with a printed coded image,

the URL contained in each of the coded images includes ID information for identifying the at least one of the article and the advertisement, whichever appropriate.

With this arrangement, if the printed matter carries a plurality of articles or advertisements and each of the articles or advertisements shown on the printed matter is provided with a printed coded image, the URL contained in each of the coded images includes ID information for identifying the article or the advertisement, whichever appropriate, so that it is possible to study and/or analyze with ease the extent of attention and/or responses to each of the articles or the advertisements.

(8) The marketing research method according to (1) above, wherein the information resource is an information resource belonging to the issuer of the printed matter.

With this arrangement, since the information resource is an information resource belonging to the issuer of the printed matter, it is possible for the issuer of the printed matter to study and/or analyze with ease the extent of attention and/or responses to each of the articles or the advertisements.

(9) The marketing research method according to (1) above, wherein

if a plurality of printed matters containing a same advertisement is involved and the advertisement of each of the printed matters is accompanied by a coded image specific to the printed matter,

the information resource is an information resource belonging to the sponsor of the advertisement.

With this arrangement, if a plurality of printed matters containing a same advertisement is involved and the advertisement of each of the printed matters is accompanied by a coded image specific to the printed matter, the information resource is an information resource belonging to the sponsor of the advertisement so that it is possible for the advertisement sponsor to study and/or analyze with ease the extent of attention and/or responses to each of the advertisements printed in the respective printed matters particularly in terms of difference among the printed matters.

(10) The marketing research method according to (1) above, wherein the access information on the accesses to the information resource includes at least one of number of accesses, date and time of each of the accesses and data on each of persons who accessed.

With this arrangement, since the access information on the accesses to the information resource includes the number of accesses and the date and time of each of the accesses and/or the data on each of the persons who accessed, it is possible to study and/or analyze with ease the extent of attention and/or responses to the printed matter from various different points of view.

(11) The marketing research method according to (1) above, wherein the coded image includes information on at least one of a sound, an image and a text in addition to the URL.

With this arrangement, since the coded image includes information on a sound, an image and/or a text in addition to the URL, each person who reads the coded image can immediately obtain sound information, text information or the like that allows the person to confirm the URL at the time when the person reads the coded image so that the person may have fun in reading the coded image.

(12) A printed matter having copies to be distributed to at least one of specified and unspecified persons and to be used for a marketing research, the printed matter comprising:

a part carrying visually readable printed image including at least one of characters and photographic image; and

a part carrying an optically readable coded image as obtained by encoding the URL to be used for specifying an information resource for the printed matter on World Wide Web connected to Internet by an access device, wherein

when the coded image is optically read by a reading device, the URL is restored from the read coded image and the information resource corresponding to the restored URL is accesses by the access device connected to the reading device, access information on the accesses in the information resource is utilized for a marketing research for at least one of studying and analyzing the printed matter.

The printed matter contains visually readable printed image including such as characters or photographic image and a coded image optically readable to an access device as obtained by encoding the URL. Therefore, if a reader is interested in the printed matter after reading or seeing it and wants to obtain more detailed information on it, he or she will reads the coded image printed on the printed matter by a reading device to restore the URL and then access the information resource on the WWW as specified by the URL.

Thus, it is possible to accurately and easily study and/or analyze the information accumulated for the printed matter by utilizing the information on the accesses to the information resource.

Additionally, when a printed matter is made carry a coded image of an URL by printing, the reliability of the character data of the URL can be improved in a simple way by using an error correction technique so that the URL can be read more accurately and reliably if compared with a case where the character string of the URL is simply optically read by an OCR and the information resource on the WWW is accessed by using the restored URL. As a result, for example, it will become possible to select the paper as deemed optimal for the copies of the printed matter to be distributed from a wide variety of different types of paper.

(13) The printed matter according to (12) above, wherein the information resource corresponding to the URL as restored from the coded image is an information resource adapted to at least one of studying and analyzing the printed matter.

With this arrangement, an information resource is provided for marketing researches apart from the ordinary information resource of the printed matter so that subsequent statistic operations for the study and/or the analysis on the printed matter can be conducted easily and efficiently.

(14) The printed matter according to (12) or (13) above, wherein the URL includes ID information for identifying the printed matter.

With this arrangement, since the URL includes ID information for identifying the printed matter, the information on the printed matter can be automatically sorted out for the study and/or the analysis on the printed matter so that the subsequent statistic operations for the study and/or the analysis on the printed matter can be conducted easily and efficiently.

(15) The printed matter according to (14) above, wherein the ID information includes at least one of a name of the printed matter, a type of the printed matter, a date of distribution of copies of the printed matter, a distribution area of copies of the printed matter and a purpose of distribution of copies of the printed matter as identifiable information.

With this arrangement, since the ID information includes at least one of the name of the printed matter, the type of the printed matter, the date of distribution of copies of the printed matter, the distribution area of copies of the printed matter and the purpose of distribution of copies of the printed matter as identifiable information, the subsequent statistic operations for the study and/or the analysis on the printed matter can be conducted easily and efficiently.

(16) The printed matter according to (12) above, wherein the coded image further contains a browser starting program for starting a browser for the access device.

With this arrangement, since the coded image further contains a browser starting program for starting a browser for the access device, the person who accesses the information resource can immediately access it simply by reading the coded image without starting the browser.

(17) The printed matter according to (12) above, wherein the printed matter is one of a newspaper, a magazine, a book, a journal, a pamphlet, a catalog, a leaflet and a ticket.

With this arrangement, it is possible to study and/or analyze the extent of attention and/or responses to the printed matter that may be a newspaper, a magazine, a book, a journal, a pamphlet, a catalog, a leaflet or a ticket.

(18) The printed matter according to (12) above, wherein

if the printed matter carries at least one of a plurality of articles and advertisements and the at least one of each article and each advertisement shown on the printed matter is provided with a printed coded image,

the URL contained in each of the coded images further includes ID information for identifying the at least one of the article and the advertisement, whichever appropriate.

With this arrangement, if the printed matter carries a plurality of articles or advertisements and each of the articles or advertisements shown on the printed matter is provided with a printed coded image, the URL contained in each of the coded images includes ID information for identifying the article or the advertisement, whichever appropriate, so that it is possible to study and/or analyze with ease the extent of attention and/or responses to each of the articles or the advertisements.

(19) The printed matter according to (12) above, wherein the information resource is an information resource belonging to the issuer of the printed matter.

With this arrangement, since the information resource is an information resource belonging to the issuer of the printed matter, it is possible for the issuer of the printed matter to study and/or analyze with ease the extent of attention and/or responses to each of the articles or the advertisements.

(20) The printed matter according to (12) above, wherein

if a plurality of printed matters containing a same advertisement is involved and the advertisement of each of the printed matters is accompanied by a coded image specific to the printed matter,

the information resource is an information resource belonging to the sponsor of the advertisement.

With this arrangement, if a plurality of printed matters containing a same advertisement is involved and the advertisement of each of the printed matters is accompanied by a coded image specific to the printed matter, the information resource is an information resource belonging to the sponsor of the advertisement so that it is possible for the advertisement sponsor to study and/or analyze with ease the extent of attention and/or responses to each of the advertisements printed in the respective printed matters particularly in terms of difference among the printed matters.

(21) The printed matter according to (12) above, wherein the access information on the accesses to the information resource includes at least one of number of accesses, date and time of each of the accesses and data on each of persons who accessed.

With this arrangement, since the access information on the accesses to the information resource includes the number of accesses and the date and time of each of the accesses and/or the data on each of the persons who accessed, it is possible to study and/or analyze with ease the extent of attention and/or responses to the printed matter from various different points of view.

(22) The printed matter according to (12) above, wherein the coded image includes information on at least one of a sound, an image and a text in addition to the URL.

With this arrangement, since the coded image includes information on a sound, an image and/or a text in addition to the URL, each person who reads the coded image can immediately obtain sound information, text information or the like that allows the person to confirm the URL at the time when the person reads the coded image so that the person may have fun in reading the coded image.

(23) An information resource to be used in a marketing research for at least one of studying and analyzing a printed matter containing visually readable printed image including at least one of characters and photographic image and an optically readable coded image as obtained by encoding the URL to be used for specifying an information resource for the printed matter on World Wide Web connected to Internet by an access device, copies of the printed matter being distributed to one of specified and unspecified persons, the marketing research utilizing access information obtained for each access to the information resource as a result of an operation of optically reading a coded image of a reading device, restoring the URL from the read coded image and accessing the information resource corresponding to the restored URL by the access device connected to the reading device; the information resource comprising:

information transmission means for transmitting the information to be displayed on the access device in response to an access by the access device; and

storage means for storing the access information.

The printed matter contains visually readable printed images such as characters or photographic image and a coded image optically readable to an access device as obtained by encoding the URL. Therefore, if a reader is interested in the printed matter after reading or seeing it and wants to obtain more detailed information on it, he or she will reads the coded image printed on the printed matter by a reading device to restore the URL and then access the information resource on the WWW as specified by the URL.

Since the information resource is provided with storage means for storing access information on the accesses made to it, it possible to accurately and easily study and/or analyze the information accumulated on the printed matter.

(24) The information resource according to (23) above, wherein the information resource is an information resource belonging to the issuer of the printed matter.

With this arrangement, since the information resource is an information resource belonging to the issuer of the printed matter, it is possible for the issuer of the printed matter to study and/or analyze with ease the extent of attention and/or responses to each of the articles or the advertisements.

(25) The information resource according to (23) above, wherein

if a plurality of printed matters containing a same advertisement is involved and the advertisement of each of the printed matters is accompanied by a coded image specific to the printed matter,

the information resource is an information resource belonging to the sponsor of the advertisement.

With this arrangement, if a plurality of printed matters containing a same advertisement is involved and the advertisement of each of the printed matters is accompanied by a coded image specific to the printed matter, the information resource is an information resource belonging to the sponsor of the advertisement so that it is possible for the advertisement sponsor to study and/or analyze with ease the extent of attention and/or responses to each of the advertisements printed in the respective printed matters particularly in terms of difference among the printed matters.

(26) The information resource according to (23) above, wherein the access information on the accesses to the information resource includes at least one of number of accesses, date and time of each of the accesses and data on each of persons who accessed.

With this arrangement, since the access information on the accesses to the information resource includes the number of accesses and the date and time of each of the accesses and/or the data on each of the persons who accessed, it is possible to study and/or analyze with ease the extent of attention and/or responses to the printed matter from various different points of view.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A marketing research method for at least one of studying and analyzing a printed matter containing visually readable printed image including at least one of characters and photographic image and an optically readable coded image as obtained by encoding the URL to be used for specifying an information resource for the printed matter on World Wide Web connected to Internet by an access device, copies of the printed matter being distributed to one of specified and unspecified persons, said method comprising the steps of:
storing access information obtained for each access to the information resource as a result of an operation of optically reading said coded image of a reading device, restoring said URL from the read coded image and accessing said information resource corresponding to the restored URL by said access device connected to said reading device; and
at least one of studying and analyzing the printed matter by utilizing the access information on the accesses as stored in said information resource.

2. The marketing research method according to claim 1, wherein said information resource corresponding to said URL as restored from said coded image is an information resource adapted to at least one of studying and analyzing the printed matter.

3. The marketing research method according to claim 2, wherein said URL includes ID information for identifying said printed matter.

4. The marketing research method according to claim 3, wherein said ID information includes at least one of a name of the printed matter, a type of the printed matter, a date of distribution of copies of the printed matter, a distribution area of copies of the printed matter and a purpose of distribution of copies of the printed matter as identifiable information.

5. The marketing research method according to claim 1, wherein said URL includes ID information for identifying said printed matter.

6. The marketing research method according to claim 5, wherein said ID information includes at least one of a name of the printed matter, a type of the printed matter, a date of distribution of copies of the printed matter, a distribution area of copies of the printed matter and a purpose of distribution of copies of the printed matter as identifiable information.

7. The marketing research method according to claim 1, wherein said coded image further contains a browser starting program for starting a browser for said access device.

8. The marketing research method according to claim 1, wherein said printed matter is one of a newspaper, a magazine, a book, a journal, a pamphlet, a catalog, a leaflet and a ticket.

9. The marketing research method according to claim 1, wherein
if said printed matter carries at least one of a plurality of articles and advertisements and the at least one of each article and each advertisement shown on the printed matter is provided with a printed coded image,
the URL contained in each of the coded images includes ID information for identifying the at least one of the article and the advertisement, whichever appropriate.

10. The marketing research method according to claim 1, wherein said information resource is an information resource belonging to the issuer of the printed matter.

11. The marketing research method according to claim 1, wherein
if a plurality of printed matters containing a same advertisement is involved and the advertisement of each of the printed matters is accompanied by a coded image specific to the printed matter,
said information resource is an information resource belonging to the sponsor of the advertisement.

12. The marketing research method according to claim 1, wherein the access information on the accesses to the information resource includes at least one of number of accesses, date and time of each of the accesses and data on each of persons who accessed.

13. The marketing research method according to claim 1, wherein said coded image includes information on at least one of a sound, an image and a text in addition to said URL.

14. A printed matter having copies to be distributed to at least one of specified and unspecified persons and to be used for a marketing research, said printed matter comprising:
a part carrying visually readable printed image including at least one of characters and photographic image; and
a part carrying an optically readable coded image as obtained by encoding the URL to be used for specifying an information resource for the printed matter on World Wide Web connected to Internet by an access device, wherein
when said coded image is optically read by a reading device, said URL is restored from the read coded image and said information resource corresponding to the restored URL is accesses by said access device connected to said reading device, access information on the accesses in said information resource is utilized for a marketing research for at least one of studying and analyzing the printed matter.

15. The printed matter according to claim 14, wherein said information resource corresponding to said URL as restored from said coded image is an information resource adapted to at least one of studying and analyzing the printed matter.

16. The printed matter according to claim 15, wherein said URL includes ID information for identifying said printed matter.

17. The printed matter according to claim 16, wherein said ID information includes at least one of a name of the printed matter, a type of the printed matter, a date of distribution of copies of the printed matter, a distribution area of copies of the printed matter and a purpose of distribution of copies of the printed matter as identifiable information.

18. The printed matter according to claim 14, wherein said URL includes ID information for identifying said printed matter.

19. The printed matter according to claim 18, wherein said ID information includes at least one of a name of the printed matter, a type of the printed matter, a date of distribution of copies of the printed matter, a distribution area of copies of the printed matter and a purpose of distribution of copies of the printed matter as identifiable information.

20. The printed matter according to claim 14, wherein said coded image further contains a browser starting program for starting a browser for said access device.

21. The printed matter according to claim 14, wherein said printed matter is one of a newspaper, a magazine, a book, a journal, a pamphlet, a catalog, a leaflet and a ticket.

22. The printed matter according to claim 14, wherein
if said printed matter carries at least one of a plurality of articles and advertisements and the at least one of each article and each advertisement shown on the printed matter is provided with a printed coded image,
the URL contained in each of the coded images further includes ID information for identifying the at least one of the article and the advertisement, whichever appropriate.

23. The printed matter according to claim 14, wherein said information resource is an information resource belonging to the issuer of the printed matter.

24. The printed matter according to claim 14, wherein
if a plurality of printed matters containing a same advertisement is involved and the advertisement of each of the printed matters is accompanied by a coded image specific to the printed matter,
said information resource is an information resource belonging to the sponsor of the advertisement.

25. The printed matter according to claim 14, wherein the access information on the accesses to the information resource includes at least one of number of accesses, date and time of each of the accesses and data on each of persons who accessed.

26. The printed matter according to claim 14, wherein said coded image includes information on at least one of a sound, an image and a text in addition to said URL.

27. An information resource to be used in a marketing research for at least one of studying and analyzing a printed matter containing visually readable printed image including at least one of characters and photographic image and an optically readable coded image as obtained by encoding the URL to be used for specifying an information resource for the printed matter on World Wide Web connected to Internet by an access device, copies of the printed matter being distributed to one of specified and unspecified persons, the marketing research utilizing access information obtained for each access to the information resource as a result of an operation of optically reading a coded image of a reading device, restoring the URL from the read coded image and accessing said information resource corresponding to the restored URL by said access device connected to said reading device; said information resource comprising:
information transmission means for transmitting the information to be displayed on said access device in response to an access by said access device; and
storage means for storing the access information.

28. The information resource according to claim 27, wherein said information resource is an information resource belonging to the issuer of the printed matter.

29. The information resource according to claim 27, wherein
if a plurality of printed matters containing a same advertisement is involved and the advertisement of each of the printed matters is accompanied by a coded image specific to the printed matter,
said information resource is an information resource belonging to the sponsor of the advertisement.

30. The information resource according to claim 27, wherein the access information on the accesses to the information resource includes at least one of number of accesses, date and time of each of the accesses and data on each of persons who accessed.
